(19) United States
(12) Patent Application Publication
(10) Pub. No.: US 2024/0185825 A1
(43) Pub. Date: Jun. 6, 2024

(54) METHOD FOR REDUCING NOISE IN MACHINES

(71) Applicant: Esra SARIASLAN, Meram/Konya (TR)

(72) Inventor: Esra SARIASLAN, Meram/Konya (TR)

(21) Appl. No.: 18/287,873

(22) PCT Filed: Apr. 20, 2022
(86) PCT No.: PCT/TR2022/050351

§ 371 Date: Oct. 21, 2023

(30) Foreign Application Priority Data
Apr. 21, 2021 (TR) 2021/006935

(51) Int. Cl. G10K 11/178

(52) U.S. Cl. CPC G10K 11/17823; G10K 11/17825; G10K 11/17881; G10K 2210/109; G10K 2210/3026; G10K 2210/3027; G10K 2210/3044

(57) ABSTRACT

The present invention; It is about the method developed to reduce noise in machines such as compressors that compress air and gases to higher pressures, and compressors and generators that emit high noise, such as generators that convert mechanical energy into electrical energy, using the active sound suppression method, and the device designed by positioning according to this method. The system developed with the present invention is a noise reduction method in high-noise machines and includes ANC integrated (200), microphone (100), loudspeaker (400), and is mainly used in machines such as generators and compressors.

### TECHNICAL AREA

The present invention; It is related to the system designed to reduce noise by using active sound suppression method in machines that emit high noise, such as a compressor that compresses air and gases to higher pressures, and a generator that converts mechanical energy into electrical energy. The system developed with the present invention is a noise reduction method in high-noise machines and includes ANC integrated (200), microphone (100), loudspeaker (400), and is mainly used in generators and compressors.

### STATE OF THE ART

Devices such as compressors that meet the needs of machines and tools working with compressed air by compressing the air taken from the atmosphere, and generators that convert mechanical energy into electrical energy are frequently used in our lives, especially in industrial areas, and their use is increasing.

Generators, which are frequently used in hospitals, schools, factories and other workplaces, are the most ideal machines to ensure the continuity of electrical energy systems. It is divided into classes according to the types of fuel used, and diesel generators are one of them.

Compressors, which are in the group of machines that compress the air taken from the atmosphere and enable it to be used when necessary, are used in a wide range of areas such as industry, construction, automotive and workshop in the world. Compressors, which are gathered in two main groups in terms of the method used in air compression, are also classified according to their working style. Screw compressors are compressors that use an interlocking rotor pair instead of a piston. It is a positive displacement machine whose threads engage each other to produce compressed air, with one of the two worm screws moving the other, compressing the gas.

In the chamber of these machines (509), there is an opening (800) to transfer the heat caused by the rotating systems to the outside. The noise caused by the leakage of this opening makes it difficult to use machines such as compressors and generators, which are required to be used. Along with the damage to the environment caused by noise, it reduces working efficiency and threatens human health.

Recently, developments have been made as a solution to this problem, and studies on passive noise suppression and active noise suppression as one of the best methods are concentrated. In this method, which gains importance day by day, designs and equipment have been developed to prevent the sounds that are not wanted to be perceived by the users.

One of the techniques used under normal conditions, earphones and similar systems designed to detect noise less, are not efficient enough for users, but the problems brought about by the difficulty of use are increasing. Situations such as being specific to each user in terms of hygiene and having to be changed at certain intervals are among the main problems, increasing the costs and bringing the need for more ergonomic and more radical solutions.

One of these solutions; They are systems and designs that focus on the main source of noise and prevent or prevent noise before sound signals reach the user. Techniques that include active or passive noise canceling systems are used more frequently as they offer more effective solutions.

Active Noise Cancelling, which we will define as ANC as its technical abbreviation, in the following sections of the description, is based on the principle of attenuation of reverse-phase sound waves. This method is based on the principle of blocking or reducing the noise. It is a method of attenuating the unwanted sound of a reverse-phase second sound, specifically designed to dampen the primary sound.

Sound is a pressure wave that consists of periods of compression and sparseness. The noise canceling speaker emits an antiphase (reverse phase) sound wave with the same amplitude as the original sound. The waves combine to create a new wave in a process called interference, and they annihilate each other, an effect called destructive interference.

Modern active noise control is usually achieved through the use of analog circuits or digital signal processing. Adaptive algorithms are designed to analyze the waveform of background auditory or non-audible noise. It then generates a signal that will phase shift or reverse the polarity of the original signal based on the particular algorithm. This inverted signal (in antiphase) is then amplified and a transducer creates destructive interference, creating a sound wave proportional to the amplitude of the original waveform. This effectively reduces the volume of detectable noise.

A noise canceling speaker may co-exist with the attenuated sound source. In this case, in order to eliminate the noise, the unwanted sound must have the same sound power level as the source. Alternatively, the transducer emitting the cancellation signal can be positioned where sound attenuation is desired (eg, the user's ear). This requires a much lower power level to eliminate the sound, but is only effective for a single user. Elsewhere, noise canceling is more difficult as it can couple with the three-dimensional wavefronts of unwanted sound to create alternating zones of constructive and destructive interference, reducing noise at some points while doubling the noise at others. In small confined spaces (for example, the passenger compartment of a car), global noise reduction can be achieved with multiple loudspeakers and feedback microphones and by measuring the modal responses of the enclosure.

Active noise canceling systems typically implement a feedback loop that generates a noise canceling signal based on the audio signal measured by the microphone in the presence of both noise and noise canceling signal.

In such noise canceling loops, performance is controlled by a suppressor filter applied as part of the feedback loop. The suppressor filter is tried to be designed in such a way that it can be obtained with the most suitable noise canceling effect. Various algorithms and approaches are known for designing an inhibitor filter.

Acoustic sponges that provide passive noise control, which are widely used in the current technique, are not sufficient because they can provide sound insulation at 4-6% dBA level, despite their low cost. Restriction of air inlet and inadequacy in devices such as compressors and generators are also one of its different disadvantages.

Since noise is emitted from the openings that provide the air inlet and outlet in the screw compressors and generators, which are the subject of the present invention, the passive noise suppression method loses its validity and cannot be used in these systems.

With the principle of solving the problem, the active noise canceling device, which is placed on the surface of the open areas of the screw compressor and diesel generator, reads and absorbs the noise produced by the machine.

In the screw compressors and generators that are the subject of the present invention, solutions can be provided with active noise canceling devices applied from outside the machine. In this case, although the noise is reduced locally, it undesirably causes an increase in noise on the side surfaces of the speaker.

If it is placed inside the machine, noise control will be achieved before the sound spreads from its source to the environment. In our present invention, the method that deals with the subject from this aspect and the innovations we have developed in the method are included.

In prior art, noise-inducing sound sources typically implement a feedback loop where the active noise canceling system generates a noise canceling signal based on the presence of the audio signal, which can be measured by the microphone, in the presence of both the noise and the noise canceling signal. The performance of such noise canceling loops is controlled by a suppressor filter applied as part of the feedback loop. The suppressor filters are tried to be designed in such a way that the optimum noise canceling effect can be achieved. Various algorithms and approaches are known for designing an inhibitor filter.

In the document numbered U.S. Pat. No. 5,499,301, which is one of the available techniques, a similar method is used for the compressor room. This system cannot be used in enterprises that do not have a compressor room. The fact that it can only be used for compressors and businesses with a compressor room provides a solution for a very limited area. The narrow usage area brings the need for a broader solution approach.

In the existing techniques, there are different methods of realizing the invention as a solution to the problem. Issues such as passive noise canceling methods mentioned above are other innovations that address the solution. However, in these systems, it is a very costly solution as it requires a design change for all components. It would be very difficult or impossible to make this change in externally supplied components, although it would entail extra R&D costs.

Therefore, the active noise canceling method will be one of the best ways to implement the invention as a solution to the current problems.

The invention US20190136729, which is another of the existing techniques, includes a large number of modular active noise canceling devices. Each modular active noise canceling device is configured in such a way that a plurality of air filters are connected to a corresponding air filter. Each modular active noise-cancelling device in this system is a multi-modular active noise canceling device; The secondary housing includes fastener, air filter, intake hole, fastener, a second fastener, housing elements. It is a difficult situation from an ergonomic point of view if a housing of a power generation unit contains a fastener configured to connect an inlet hole to an air filter, but it is a very disadvantageous situation when evaluated in terms of assembly and maintenance.

Another of the existing techniques is the invention WO2018050787, an active noise cancellation system comprising an active noise cancellation circuit connected to a microphone arranged to detect ambient noise, an analog to digital converter (ADC) noise signal arranged to convert the detected environmental noise into a digital medium, a plurality of It includes a structured prediction filter to estimate an inverted digital environmental noise sample and generate a digital inverted environmental noise signal. Our present invention deals with the method of preventing noise from its source before it spreads to the environment without the need for a prediction filter.

### Technical Problems That the Invention Aims to Solve

The present invention aims to reduce the noise level that occurs in high power motor machines such as compressors and generators and to prevent the noise before it spreads from its source to the environment.

The present invention covers the “method of solving the problem from the source”, which was developed as a solution to the inadequacy of passive noise canceling method and active noise canceling (ANC) systems and the problems that arise with it. Experienced in systems providing passive noise control, which is widely used in the current technique; It offers a permanent solution to major problems such as restriction of air intake, insufficiency of devices such as compressors and generators.

In current ANC methods, it is to develop solutions to the problems caused by the fact that ANC devices applied from the outer surface of the machine cause more noise increase on the sides of the speaker.

Acoustic sponges that provide passive noise control, which are widely used, are not sufficient because they can provide sound insulation at the level of 4-6% dBA, despite their low cost. Restriction of air inlet and inadequacy in devices such as compressors and generators are also one of its different disadvantages.

Since noise is emitted from the openings that provide the air inlet and outlet in the screw compressors and generators, which are the subject of the present invention, the passive noise suppression method loses its validity and cannot be used in these systems.

With the principle of solving the problem, the active noise canceling device, which is placed on the surface of the open areas of the screw compressor and diesel generator, reads and absorbs the noise produced by the machine. In this case, the sound is blocked before it spreads to the environment.

In the screw compressors and generators that are the subject of the present invention, solutions can be provided with active noise canceling devices applied from outside the machine. In this case, although the noise is reduced locally, it undesirably causes an increase in noise on the side surfaces of the speaker.

If it is placed inside the machine, noise control will be achieved without spreading the sound to the environment. In our present invention, as a solution to these problems, it is aimed at the system that deals with the subject from this aspect and the innovations we have developed in the system.

### EXPLANATION OF FIGURES

FIG. 1.1—The main components of the invention are shown. (Microphone that converts sound waves to electricity, ANC that produces the opposite wave of the sensed sound wave, amphi that amplifies the signal received from the integrated and transfers it to the speaker, loudspeaker that converts the produced electrical signal into sound wave, and the power supply that provides the energy of all components.)

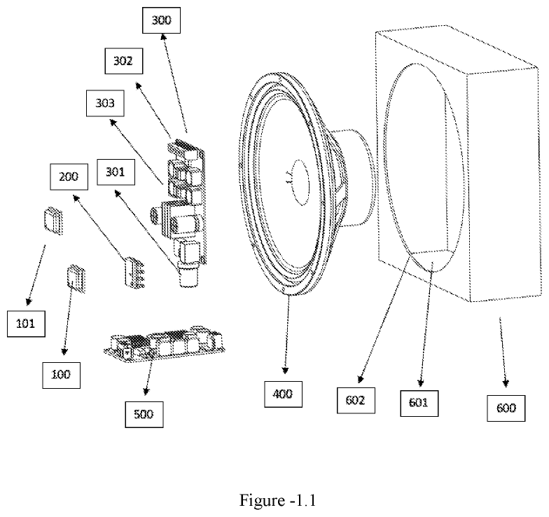

FIG. 1.2. Secondary components of the invention

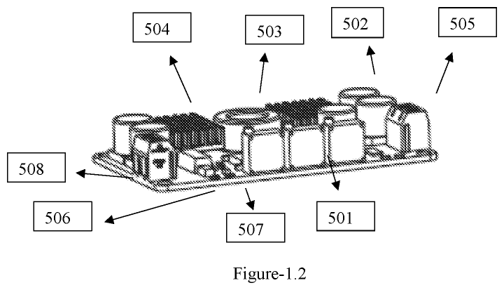

FIG. 2: Showing the method in the big picture and positioning the device designed according to the method

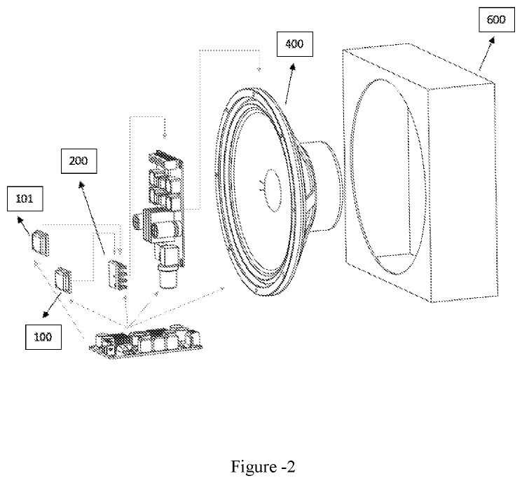

FIG. 3—General view of the device. The microphone and loudspeaker can be seen from the outside of the enclosure. Other components are housed inside the enclosure.

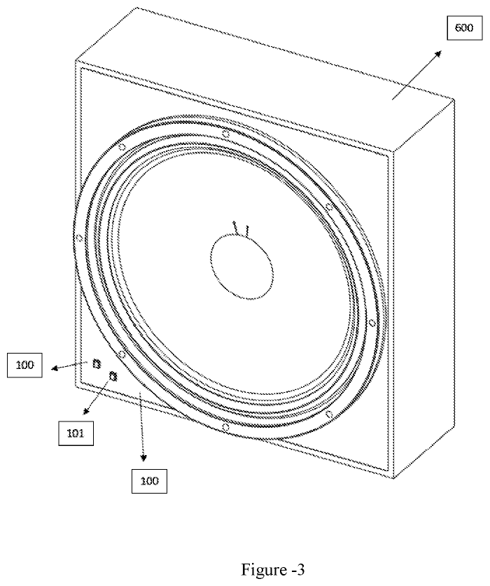

FIG. 4—The positions of the device placed inside the compressor and generator are seen

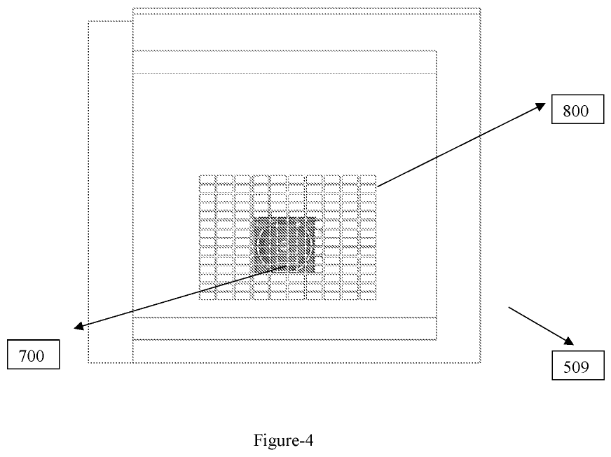

FIG. 5: Three-dimensional position of the device placed inside the compressor and generator

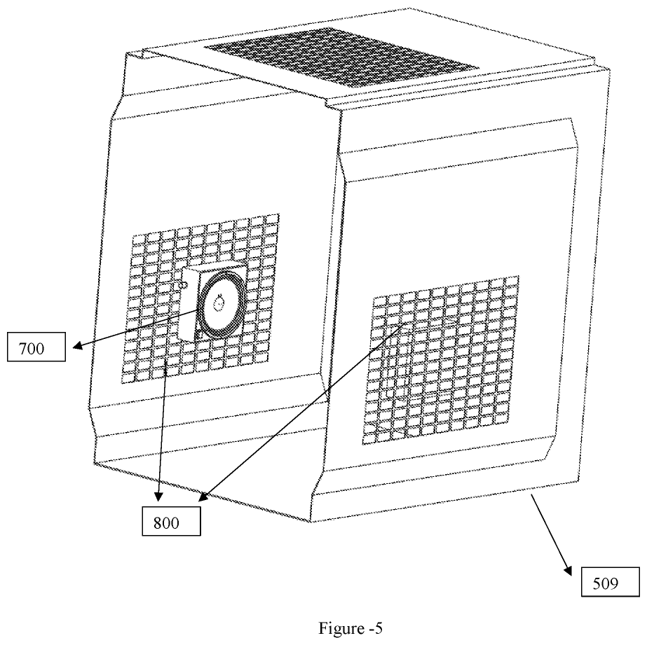

FIG. 6 Reverse phase sound waves attenuating each other

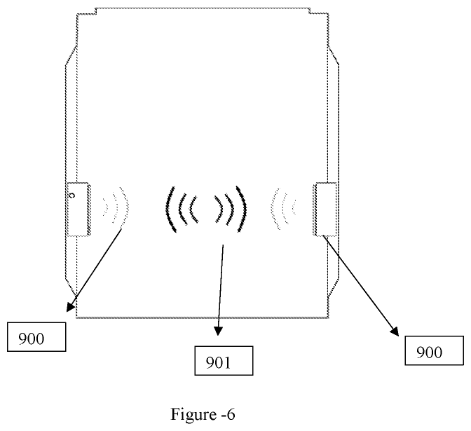

### EXPLANATION OF REFERENCES

The elements illustrated in the figures are numbered as follows:
NO ELEMENTS NAME
100 Microphone
101 Bug (error) microphone
200 ANC IC
300 Amplifier
301 Potentiometer
302 jack socket
303 Filter
400 LoudSpeaker
500 Power unit
501 Resistance
502 Condenser
503 Transformer
504 Radiator
505 Connector
506 Cable
507 Led bulb
508 Key
509 Screw compressor or diesel generator
600 Casing
601 Felt
602 O-ring
700 Device
800 air clearance
900 noise (opposite sound)
901 Noise

The invention consists of a microphone (100), which is mainly used in machines that create high noise such as generators and compressors, and is used for converting sound waves into electrical signals, bug (error) microphone (101) to see and correct residual noise (error) in the first sent counterwave result, ANC integrated (200), which provides the production of the opposite wave of the sensed sound wave, and speaker amplifier (401) that provides amplification of the signal received from the integrated and transferred to the loudspeaker (401). Speaker (400), which provides the conversion of the electrical signal produced into sound, power unit (500) that provides the power requirement of all components, resistor (501), which allows the limitation and regulation of the current of the circuit, capacitor (502), which provides the power control of the circuit, Transformer (which provides the regulation of the voltage of the circuit). 503), Radiator that provides cooling of the electronic board (504), Terminal block for cable connection points (505), Cable for power transmission (506), potentiometer for controlling sound power (301), screw for making mechanical connections (510), inside components enclosure (600), Ka Jack socket(302) as a kind of connection element connected to the block end, Felt that allows to prevent sound propagation from the back of the speaker (601), O-ring that prevents air inlet and outlet inside the enclosure (602), Filter that prevents sound feedback noise (303), The light led bulb (507), which indicates that the device is working, includes a switch (508) that enables the device to be turned on and off.

### DETAILED DESCRIPTION OF THE INVENTION

In order to provide air suction in screw compressors and machines such as diesel generators, openings must be left in the bodywork surrounding the machine. Noise, which must be eliminated with passive noise suppression systems inside the compressor, spreads to the environment due to these obligatory openings.

Active Noise Cancelling is based on the attenuation of reverse-phase sound waves. This method is based on the principle of blocking or reducing noise. It is a method of attenuating the unwanted sound of a reverse-phase second sound, specifically designed to dampen the primary sound.

Sound is a pressure wave that consists of periods of compression and sparseness. The noise canceling speaker emits an antiphase (reverse phase) sound wave with the same amplitude as the original sound. The waves combine to create a new wave in a process called interference, and they annihilate each other, an effect called destructive interference.

Modern active noise control is usually achieved through the use of analog circuits or digital signal processing. Adaptive algorithms are designed to analyze the waveform of background audible or non-audible noise, then generate a signal that will either phase shift or reverse the polarity of the original signal based on the particular algorithm. This inverted signal (in antiphase) is then amplified and a transducer creates destructive interference, creating a sound wave proportional to the amplitude of the original waveform. This effectively reduces the volume of detectable noise.

A noise canceling speaker can coexist with the attenuated sound source. In this case, in order to eliminate the noise, the unwanted sound must have the same sound power level as the source. Alternatively, the transducer emitting the cancellation signal can be positioned where sound attenuation is desired (eg, the user's ear). This requires a much lower power level to eliminate the sound, but is only effective for a single user. Elsewhere, noise canceling is more difficult as it can couple with the three-dimensional wavefronts of unwanted sound to create alternating zones of constructive and destructive interference, reducing noise at some points while doubling the noise at others. In small confined spaces (for example, the passenger compartment of a car), global noise reduction can be achieved with multiple loudspeakers and feedback microphones and by measuring the modal responses of the enclosure.

Active noise canceling systems typically implement a feedback loop that generates a noise canceling signal based on the audio signal measured by the microphone in the presence of both noise and noise canceling signal.

The method developed specifically for the aforementioned situations and the device specially designed for the method is positioned in a way to prevent noise from escaping out of the machine through the obligatory openings (800) in machines such as the noise that must be eliminated with passive noise suppression systems inside the devices such as generators and compressors.

1. This device (700) converts sound waves into electrical signals via a microphone.

2. The converted electrical signals are directed to the ANC integrated (200).

3. The ANC circuit 200 generates the opposite wave of the sound wave.

4. The signal received from the integrated is amplified by the speaker amplifier (401) and transferred to the speaker (400).

5. The loudspeaker 400 provides the conversion of the generated electrical signal into sound.

The power unit is also located inside the device to provide the power requirement of all components. The number of devices, the component sizes and powers in the device may vary according to the machine size in which the device will be used.

1- The present invention; It is related to the method developed to reduce or prevent the high volume noise that occurs in machines with forced air opening (800), such as compressors and generators, using the active sound suppression method, and the device (700) designed by positioning in accordance with this method, and its feature is; it can be used as a new noise canceling method by positioning (700, 800, 509) in the interior of high-noise machines (509) to reduce noise, with active noise canceling method (ANC),
In order for the device (700) to be able to cut or reduce the noise from its source after being positioned in the machine (509); it includes a microphone (100) that allows the sound waves to be converted into electrical signals, and an ANC IC (200) that produces the opposite wave of the sound wave (901) of the perceived noise,
It contains an error microphone (101) located outside of the compressor to see and correct the noise (error) remaining in the first counter wave result,
The signal received from the integrated is amplified by the speaker amplifier (401), and the electrical signal produced is transferred to the speaker (400), which converts it into sound.

2- The present invention, while having the features in the first claim, is a device designed to prevent the noise in the machines (in machines such as compressors and generators) with the help of the ANC integrated (200), unlike the sound, sound waves and or noise source that occurs in the machines, unlike the existing techniques. The situation of solving the noise from its source is provided by the steps in claim-1.

3- Although the present invention has the features of claim-1 and claim-2; The power unit that allows the power requirement of all components to be provided, the resistor that provides the limitation and regulation of the current of the circuit, the capacitor to control the power of the circuit, the terminal containing the cable connection points, the potentiometer that allows the audio power to be controlled, the Jack socket as a kind of connector connected to the cable end, inside the components It contains an enclosure as the box in which it will be placed.
